(19) United States
(12) Patent Application Publication
(10) Pub. No.: US 2012/0227858 A1
(43) Pub. Date: Sep. 13, 2012

(54) Apparatus for Separating the Connecting Ends of Twisted Wires

(76) Inventors: Karl Kean, Chicago, IL (US); Dan O'Shea, Oak Lawn, IL (US); Nancy Klinger, Chicago Ridge, IL (US)

(21) Appl. No.: 13/045,060

(22) Filed: Mar. 10, 2011

(51) Int. Cl. H02G 1/00; H01R 43/28; H02G 1/12

(52) U.S. Cl. 140/123; 29/412; 29/825; 29/857

(57) ABSTRACT

An apparatus and a method for readily untwisting the ends of a plurality of twisted wire conductors that are to be stripped and connected to the terminals of an electrical or electronic apparatus. The apparatus comprises a shank having an end, and an elongated-shaped slot located in an end of the shank. The elongated-shaped slot extends into the shank a predetermined distance, and the slot has an opening adapted to receive the twisted wire conductors. The elongated-shaped slot has two spaced-apart and substantially parallel walls that engage and grip the twisted wire conductors when the wires are inserted into the elongated-shaped slot and the shank is rotated in a direction opposite the direction of twist of the wire conductors. After inserting the ends of a plurality of twisted wire conductors into the elongated-shaped slot of the shank, the shank is rotated in the direction opposite the direction of twist of the wire conductors. The separated conductor wires are then removed from the elongated-shaped slot, the wire ends are further separated and striped of insulation, and the wires are then connected to the terminals of an electrical or electronic apparatus.

### FIELD OF THE INVENTION

The present invention relates to separating the ends of twisted wire assemblies, and more particularly to an apparatus than when applied to twisted wire assemblies and rotated, will separate the wire ends, making the wire ends more readily available for insulation stripping and connecting to a terminal of an electronic or electrical device.

### BACKGROUND OF THE INVENTION

The rapid increase in the use of electronic and electrical products on a global scale has generated the need for skilled technicians to hard-wire electronic and electrical units into network configurations more rapidly and more extensively then previously. Many of the wires used in completing these hard-wired connections with terminals on the electronic equipment are provided as a plurality of twisted conductor wire pairs, with each conductor wire having a separate insulating cover. The twisted wires may also be provided with more than two wires twisted together for purposes of using the present invention. For convenience the present invention is described as adapted to untwist intertwined wire pairs, however, the apparatus and method of the present invention are applicable to multiple twisted wire structures.

Commonly, a plurality of individually insulated twisted wires are provided in a length of sheath that encloses several lengths of twisted wire pairs, with the sheath providing an extra measure of insulation. A flexible, solid core member may also extend along the length of the sheath. The core member is normally disposed between the plurality of twisted wire pairs to provide support for, and assist in maintaining the integrity of, the conductor wires encompassed by the sheath, and to absorb a portion of shock forces when the sheath is accidently impacted by outside forces. In addition, each conductor wire pair may include a non-conductive strand that is also twisted with each wire pair in the sheath. This strand also provides a degree of support and integrity to each twisted wire pair.

In using wires to complete an electrical connection, the portion of the sheath adjacent the end of the wire length is removed. Then, the twisted wire pairs must be untwisted along a length of about ½ inch to 1¼ inches from the tip of each wire, whereby each wire of a twisted pair is separated from the other wire. This is followed by removing, or striping, the insulation from the tip of each wire. In this configuration the separated and exposed tips of the wire pair are ready to be connected to the terminals of a piece of electrical or electronic equipment.

Presently, the procedure for untwisting each twisted pair prior to stripping the insulation and making a connection with a terminal is performed by the wiring specialist using his or her fingers to untwist the wires. Since the ends of the wires are sharp, this procedure may injure the fingers of the technician. In addition, if the technician's fingers are coated with a slippery substance, the twisted wires will sip through the technician's fingers, and remain twisted. Further, the task of untwisting the plurality of twisted wire pairs in a single sheath may be time consuming, thereby increasing the cost of labor in making the desired electrical connection.

Therefore, it is an object of the present invention to provide a device and method that can be readily used by a technician to quickly and efficiently untwist the connective ends of a twisted wire pair prior to stripping insulation from each of the wires comprising the twisted pair, and connecting the ends of each wire to the terminals of electrical or electronic equipment.

### SUMMARY OF THE INVENTION

An apparatus and a method are disclosed for readily untwisting the ends of a plurality of twisted wire conductors that are to be stripped and connected to the terminals of an electrical or electronic apparatus. The apparatus comprises a shank having an end, and an elongated-shaped slot located in the end of the shank. The elongated-shaped slot extends into the shank a predetermined distance, and the slot has an opening adapted to receive the twisted wire conductors. The elongated-shaped slot has two spaced-apart substantially parallel walls that engage and grip the twisted wire conductors when the wires are inserted into the elongated-shaped slot. The shank is then rotated in a direction opposite the direction of twist of the wire conductors.

The method of the present invention comprises the steps of inserting the ends of a plurality of twisted wire conductors into an elongated-shaped slot of a shank, the slot having walls that functionally engage the ends of the twisted wire conductors. The shank is then rotated in the direction opposite the direction of twist of the wire conductors. The conductor wires are then removed from the elongated-shaped slot, the wire ends are separated and stripped of insulation, and the wires are then connected to the terminals of an electrical or electronic apparatus.

### BRIEF DESCRIPTION OF THE DRAWINGS

FIG. 1 is a top plan view of a plurality of twisted wire conductor pairs extending from a partially cut-away insulating sheath, with each conductor wire surrounded by an insulating cover, and wherein two of the wire conductor pairs are shown in their twisted configuration, and two other wire conductor pairs are shown in their untwisted state after application of the apparatus and method of the present invention;

FIG. 2 is a perspective view of the shank of the present invention, including an elongated-shaped slot formed in the shank;

FIG. 3 is a perspective view of the shank of FIG. 2, showing a twisted wire conductor pair inserted into the elongated-shaped slot;

FIG. 4 is a side view of the shank of FIG. 2;

FIG. 5 is an end view of the shank of FIG. 2, showing the location of the opening into the elongated-shaped slot;

FIGS. 6A-6E are schematic illustrations of the process of untwisting a wire pair using the invention shown in FIGS. 2-5; and

FIG. 7 is a cross-sectional view taken along line 7-7 of FIG. 3, showing the twisted conductor wires engaged by opposing walls of the elongated-shaped slot when the ends of a twisted conductor wire pair are inserted into the elongated shaped slot.

### DESCRIPTION OF THE ILLUSTRATED EMBODIMENT

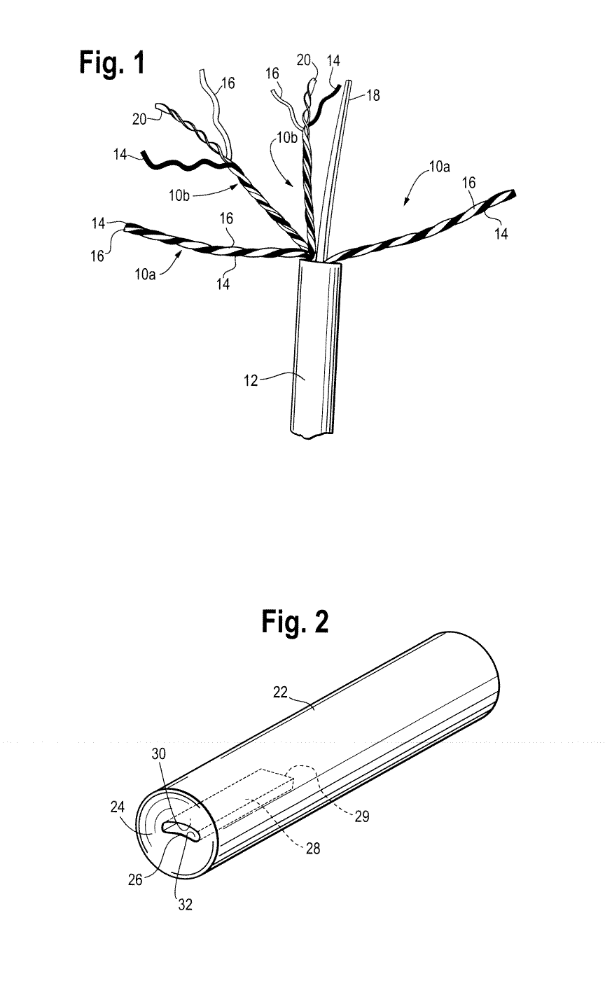

Referring to FIG. 1, a plurality of twisted or intertwined wire conductor pairs 10a and 10b are shown extending from a cut-away portion of an insulating sheath 12. The wire conductor pairs 10a, 10b extend along the length of sheath 12, and are shown removed from the sheath prior to separation, stripping and connection to the terminals of electrical or electronic equipment, as will be explained.

In the illustrated embodiment of FIG. 1, each wire conductor pair 10a, 10b each comprises two twisted or intertwined wires 14, 16 that are each covered with an insulation sleeve, as is known in the art. However, the present invention is also applicable to wire conductors twisted in braids of three or more.

The sheath 12 may also include a non-conductive longitudinal flexible core 18, made of plastic or other semi-rigid material, to provide strength and integrity to the wire conductor pairs 10a, 10b in sheath 12. In addition, each of the wire conductor pairs 10a, 10b also include a fabric or flexible plastic strand 20 twisted between each wire 14, 16 to increase the strength and integrity of each wire conductor pair 10a, 10b. As is known in the art, twisted wire pairs 10a, 10b have to be untwisted and the insulation removed from the ends of the wires before the wire conductors can be attached to the terminals of an electronic or electrical apparatus. In FIG. 1, wire conductor pairs 10a are shown in their twisted configuration, prior to the application of the untwisting apparatus and method of the present invention. Also, in FIG. 1 wire conductor pairs 10b are shown in their untwisted position, with the outer ends of wires 14 and 16 separated after the apparatus and method of the present invention have been applied to the ends of wires 14, 16. As seen in FIG. 1, the untwisted ends of wires 14, 16 are still covered by their individual insulation covers, which are removed prior to connecting the wires 14, 16 to the terminals of electronic or electrical apparatus, as is known in the art.

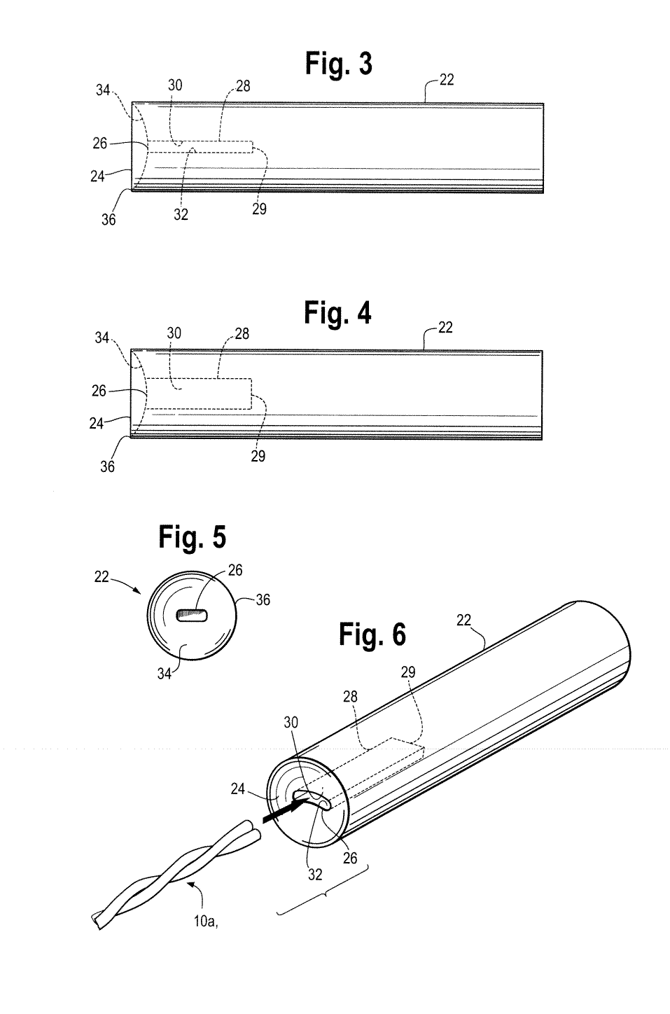

FIGS. 2-5 illustrate an embodiment of the apparatus of the present invention utilized to untwist or separate the ends of wires 14, 16 after the adjacent portion of sheath 12 has been stripped away from the ends of wires 14, 16. A shank 22 has an end 24 with an elongated opening 26 communicating with an elongated-shaped slot 28. Slot 28 extends partially along the length of shank 22 to a bottom 29. In the illustrated embodiment, as seen in FIG. 7, slot 28 includes two sidewalls 30, 32 that, in the illustrated embodiment, are substantially straight and parallel to each other, for purposes to be explained. As seen in FIG. 4, the face 34 of end 24 is concave and extends downward from rim 36 of shank 22 towards, and to, opening 26 for the purpose of guiding the ends of wires 14, 16 into elongated-shaped slot 28, as will be explained. The shank 22 is shown having a round cross-sectional configuration, however, the shank 22 can have any cross-sectional configuration that permits the shank to be rotated manually by a wiring technician, or to be rotated by a machine such as a power drill or the like.

In operation, referring to FIG. 1, the sheath 12 surrounding a plurality of wire conductor pairs 10a, 10b is trimmed to expose the ends of the wire conductor pairs. Each of the wire conductor pairs 10a, 10b are separated from the core 18, and under normal applications, the exposed portion of core 18 is cut off and discarded. At this point, the ends of each wire conductor pair remain twisted or intertwined as shown at 10a in FIG. 1.

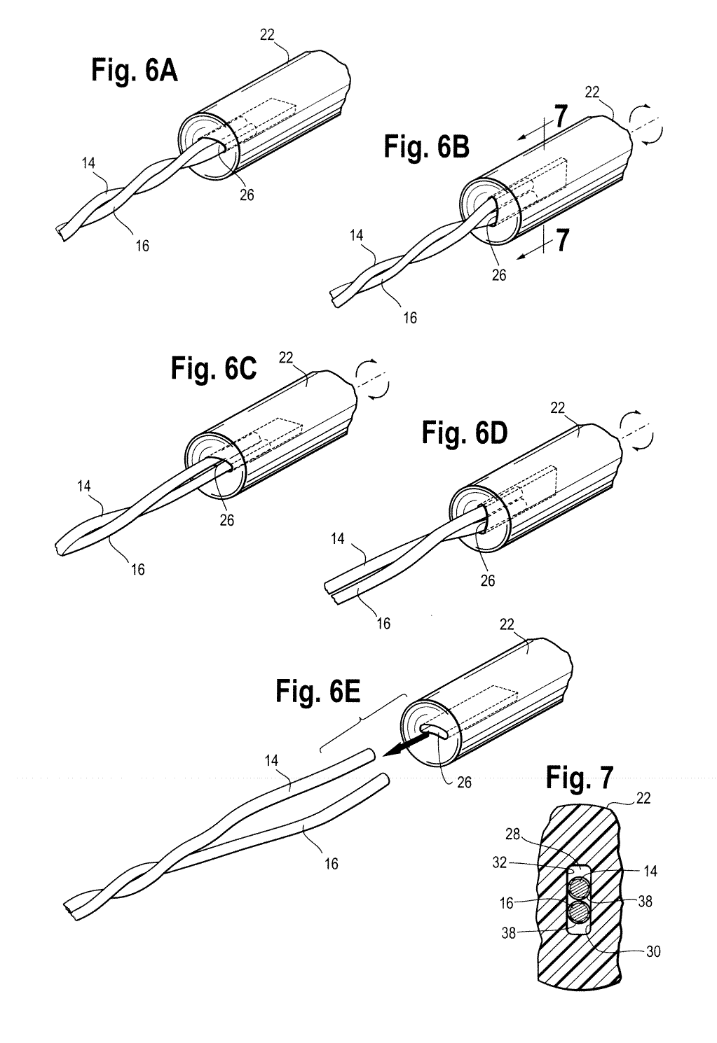

To begin the process of untwisting and separating the ends of each wire conductor pair 10a, and referring to FIGS. 6A to 6E, the ends 14, 16 of a first of the wire conducting pairs 10a are inserted into opening 26 of shank 22, using the concave face 34 of end 24 to guide the ends of the twisted wires 14, 16 of twisted wire pair 10a towards opening 26, if necessary. The wire conducting pair 10a is advanced into elongated-shaped slot 28 until the tips of the wire conducting pair abut the bottom 29 of the slot. As seen in FIG. 7, the distance between sidewalls 30 and 32 of elongated-shaped slot 28 is slightly larger than the outer diameter of the insulation 38 surrounding wires 14 and 16. The shank 22 is then rotated in the counterclockwise direction, as viewed in FIGS. 6B-6D. The outer portions of the wires 14, 16 are engaged by sidewalls 30, 32 of slot 28, thus applying an untwisting force to each wire 14 and 16. Since the distance between sidewalls 30, 32 are calibrated to be slightly greater than the outer diameters of each wire 14, 16, each wire is firmly engaged by the sidewalls 30, 32, and there is no room for the wires 14, 16 to move laterally in slot 28 other than to become separated and untwisted. The present invention contemplates that a user will possess a number of shanks 22 having openings 26 and elongated-shaped slots 28 of varying dimensions to receive and untwist wire conductor pairs 10a, 10b of varying sizes. The present invention also contemplates that the shank 22 may provide openings 26 and elongated-shaped slots 28 of varying dimensions on both ends of the shank.

As shank 22 is rotated clockwise, as viewed in FIGS. 6B-6D, the force applied to the outer portions of each insulation layer surrounding each wire 14, 16, untwists and separates the wires 14, 16 in slot 28. After rotating shank 22 for several rotations, the wires 14, 16 are withdrawn from elongated-shaped slot 28 as shown in FIG. 6E, and are then manually separated further by extending the ends of wires 14, 16 to the configuration shown at 10b in FIG. 1. The non-conducting strand 20 is normally cut off and discarded.

The exposed and separated ends of each wire 14, 16 are then stripped of about one inch of insulation, as is known in the art. The non-insulated ends of wires 14, 16 are then conductively attached to respective terminals of electronic or electrical units for the transmission of electrical signals and/or power to the units.

The foregoing description of the illustrated embodiment of the invention has been presented for purposes of illustration and description and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed:

1. An apparatus for untwisting the ends of a plurality of twisted wire conductors that are twisted together, comprising:
a shank having an end,
the end having an elongated-shaped slot therein;
the elongated-shaped slot extending into the shank a predetermined distance;
the elongated slot having an opening adapted to receive said twisted wire conductors.

2. The apparatus of claim 1, wherein:
the elongated-shaped slot includes at least two spaced apart side walls that are substantially parallel to each other, the side walls adapted to engage and grip the twisted wire conductors when the twisted wire conductors are received in the elongated-shaped slot and the shank is rotated in a direction opposite the direction of twist of the twisted wire conductors.

3. The apparatus of claim 2, wherein:
the elongated-shaped slot extends partially along a length of the shank.

4. The apparatus of claim 1, wherein:
the end of the shank includes a downwardly-sloping concave surface extending towards the elongated-shaped slot, the concave surface adapted to guide a twisted wire conductor towards said opening of said elongated-shaped slot.

5. The method of untwisting and separating the ends of a plurality of twisted wire conductors whose ends are twisted together, comprising the steps of:
inserting the ends of the plurality of twisted wire conductors into an elongated-shaped slot of a shank, the slot having walls that frictionally engage the twisted wire conductor ends;
rotating the shank in a direction opposite the direction of twist of the twisted wire conductor;
removing the wire conductor ends from the elongated shaped slot; and
separating the wire conductor ends from each other.

6. The method of claim 5, comprising the step of:
stripping insulation from the wire conductor ends after said ends have been separated.

7. The method of claim 6, comprising the step of:
attaching the stripped ends of the wire conductor ends to the terminals of an electrical device.
